(19) United States
(12) Patent Application Publication
(10) Pub. No.: US 2014/0285764 A1
(43) Pub. Date: Sep. 25, 2014

(54) FITNESS ADJUSTMENT MECHANISM FOR EYEGLASS TEMPLE

(71) Applicant: PROHERO GROUP CO., LTD., Tainan City (TW)

(72) Inventor: PEN-WEI CHEN, TAINAN CITY (TW)

(73) Assignee: PROHERO GROUP CO., LTD., Tainan City (TW)

(21) Appl. No.: 13/848,852

(22) Filed: Mar. 22, 2013

(51) Int. Cl. G02C 5/20

(52) U.S. Cl. CPC G02C 5/20
USPC 351/118

(57) ABSTRACT

A fitness adjustment mechanism for eyeglass temples is revealed. The fitness adjustment mechanism is disposed on an eyeglass frame, a temple or between the eyeglass frame and the temple. The fitness adjustment mechanism includes an adjustment hole and a projecting pin. A receiving fixing slot is formed on each of two ends of the adjustment hole and a narrow channel is located between the two receiving fixing slots. The transverse distance of the channel is smaller than an inner diameter of the receiving fixing slot. The diameter of the projecting pin is no more than the inner diameter of the receiving fixing slot and is a bit larger than the transverse distance of the channel. Thus an angle of the temple is changed by the projecting pin mounted into different receiving fixing slot for adjusting fitness of eyeglasses. People feel comfortable with the eyeglasses on.

### BACKGROUND OF THE INVENTION

1. Field of the Invention

The present invention relates to a fitness adjustment mechanism for eyeglass temples, especially to a fitness adjustment mechanism for eyeglass temples used for adjusting distance between user faces and temples. With proper adjustment, the temples fit different face shapes well with maximum comfort.

2. Description of Related Art

Generally, eyeglasses include an eyeglass frame, two lenses mounted on apertures of the eyeglass frame, and two temples pivoted to the eyeglass frame.

People's faces have different shapes. Yet the distance between two temples of the eyeglasses is fixed and is unable to be adjusted. When the distance between the temples is smaller than the width of user's face, the eyeglasses press both sides of user's head and the user feel uncomfortable after wearing the eyeglasses. When the distance between the temples is larger than the width of the face, the frame is loose and the eyeglasses slides frequently. This causes inconvenience in use.

Although some materials the eyeglasses made from allow direct adjustment of the angle the temples being bent. That means the temples are bent by a force applied. However, such way may result in changes in disposition and position of the temples. Moreover, if users less skilled in the adjustment may cause the two temples having different angles after being adjusted or even cause breakage of the temple.

While purchasing the eyeglasses, consumers usually pick up eyeglasses according to their face size and there is no need to adjust the distance between the two temples. But this restricts consumers from choosing various styles and designs of the eyeglasses.

### SUMMARY OF THE INVENTION

Therefore it is a primary object of the present invention to provide a fitness adjustment mechanism for eyeglass temples by which the distance between temples and user's face is able to be adjusted. After the temples being adjusted, the temples fit different faces properly and users feel more comfortable while wearing eyeglasses. Moreover, the structure of the temple will not be damaged.

In order to achieve the above object, a fitness adjustment mechanism of the present invention is arranged between the eyeglass frame and the temple or disposed on a temple. The fitness adjustment mechanism includes at least one adjustment hole and one projecting pin. A receiving fixing slot is formed on each of two ends of the adjustment hole and a narrow channel is located between the two receiving fixing slots. The transverse distance of the channel is smaller than an inner diameter of the receiving fixing slot. The diameter of the projecting pin is no more than the inner diameter of the receiving fixing slot and is a bit larger than the transverse distance of the channel. Thus an angle of the temple is changed by the projecting pin mounted into different receiving fixing slot.

The fitness adjustment mechanism for eyeglass temples further includes an inclined contact surface and a contact surface. The inclined contact surface and the contact surface are respectively arranged at the eyeglass frame and the temple corresponding to each other. By the projecting pin being mounted in different receiving fixing slots together with a leaning position between the contact surface and the inclined contact surface, the angle of the temple is changed and the fitness between the temple and the face is further adjusted. Thus users feel comfortable while wearing the eyeglasses.

When the fitness adjustment mechanism is disposed between the eyeglass frame and the temple, an end of the eyeglass frame that connects to the temple is further arranged with a slot. A top wall and a bottom wall of the slot are respectively set with a guide groove that communicates with the adjustment hole.

When the fitness adjustment mechanism for eyeglass temples is disposed between a first connection segment and a second connection segment of a temple, one end of the first connection segment that connects to the second connection segment is arranged with a slot while a top wall and a bottom wall of the slot are respectively disposed with a guide groove. The guide groove communicates with the adjustment hole.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an enlarged partial exploded view of an embodiment according to the present invention;

FIG. 2 is a top view of the assembly of FIG. 1 according to the present invention;

FIG. 3 is another top view of the assembly of FIG. 1 according to the present invention;

FIG. 4 is an explosive view of an embodiment according to the present invention;

FIG. 5 is an enlarged partial exploded view of another embodiment according to the present invention;

FIG. 6 is a top view of the assembly of FIG. 5 according to the present invention;

FIG. 7 is an enlarged partial top view of the assembly of FIG. 5 according to the present invention;

FIG. 8 is another top view of the assembly of FIG. 5 according to the present invention;

FIG. 9 is an enlarged partial top view of the assembly of FIG. 5 according to the present invention;

FIG. 10 is an enlarged partial top view of the assembly of a further embodiment according to the present invention;

FIG. 11 is another enlarged partial top view of the assembly of FIG. 10 according to the present invention.

### DETAILED DESCRIPTION OF THE PREFERRED EMBODIMENT

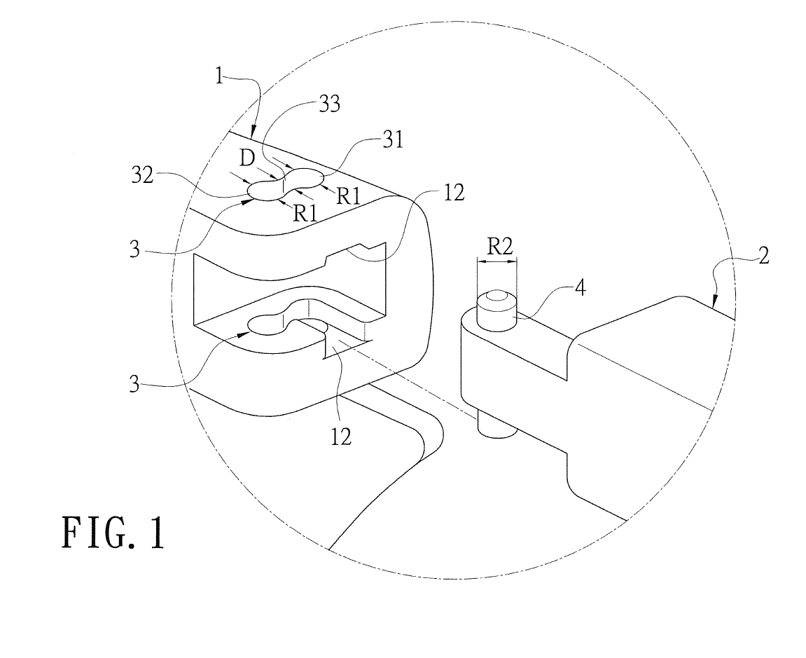

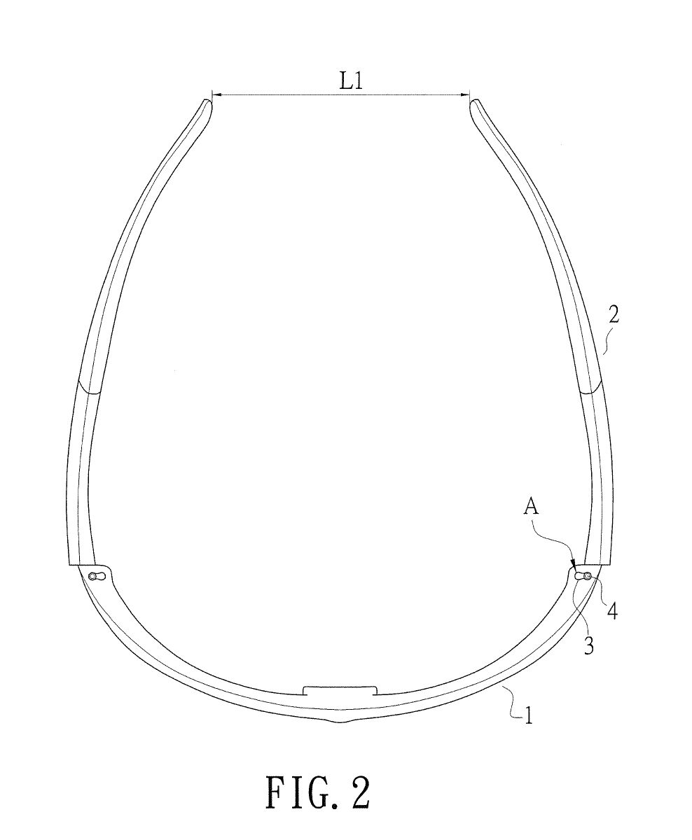

Refer to FIG. 1 and FIG. 2, a fitness adjustment mechanism A for eyeglass temples of the present invention is disposed between an eyeglass frame 1 and a temple 2. The fitness adjustment mechanism A includes at least one adjustment hole 3 and a projecting pin 4. The adjustment hole 3 is disposed on one end of the eyeglass frame 1 that connects to the temple 2. The projecting pin 4 is arranged at one end of the temple 2 that connects to the eyeglass frame 1. The end of the eyeglass frame 1 that connects to the temple 2 is further set with a slot 11. A top wall and a bottom wall of the slot 11 are respectively arranged with a guide groove 12 that communicates with the adjustment hole 3. A receiving fixing slot 31/32 is formed on each of two ends of the adjustment hole 3 and a narrow channel 33 is mounted between the two receiving fixing slots 31, 32. The transverse distance D of the channel 33 is smaller than an inner diameter R1 of the receiving fixing slot 31/32. The projecting pin 4 is mounted into the adjustment hole 3 under the guidance of the guide grooves 12 above and under the slot 11. The diameter R2 of the projecting pin 4 is no more than the inner diameter of the receiving fixing slot 31/32 and is a bit larger than the transverse distance D of the channel 33. Thus the projecting pin 4 can be mounted into either the receiving fixing slot 31 or the receiving fixing slot 32.

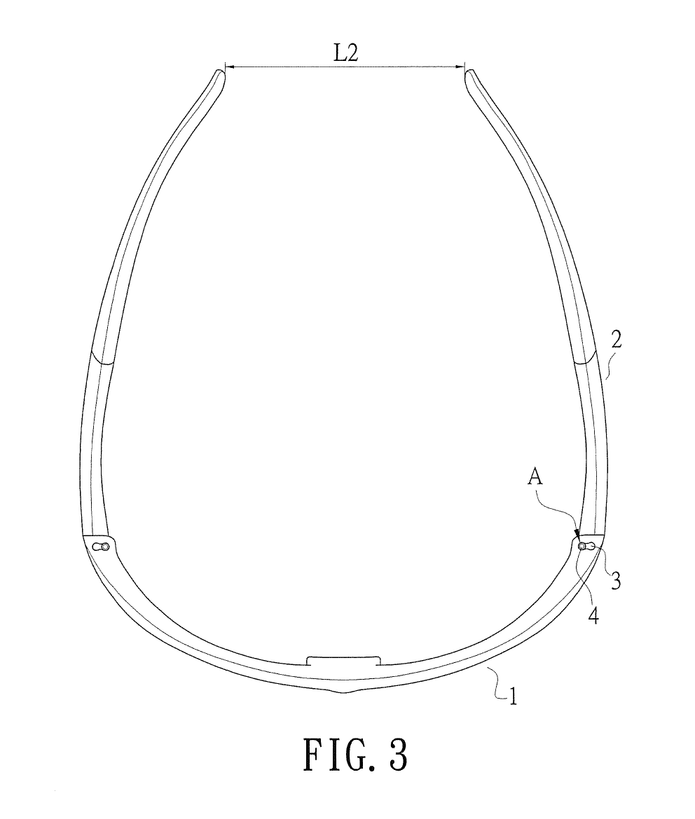

Refer to FIG. 2, a schematic drawing showing the projecting pin 4 being mounted into the receiving fixing slot 31 on an outer side of the eyeglass frame 1 is revealed. In such state, a distance L1 between two rear ends of the two temples 2 is larger compared with the other state. Refer to FIG. 3, the projecting pin 4 is mounted into the receiving fixing slot 32 on an inner side of the eyeglass frame 1. In such state, a distance L2 between two rear ends of the two temples 2 is smaller than L1 (L2<L1). Thus the fitness of the two temples 2 in this state is better.

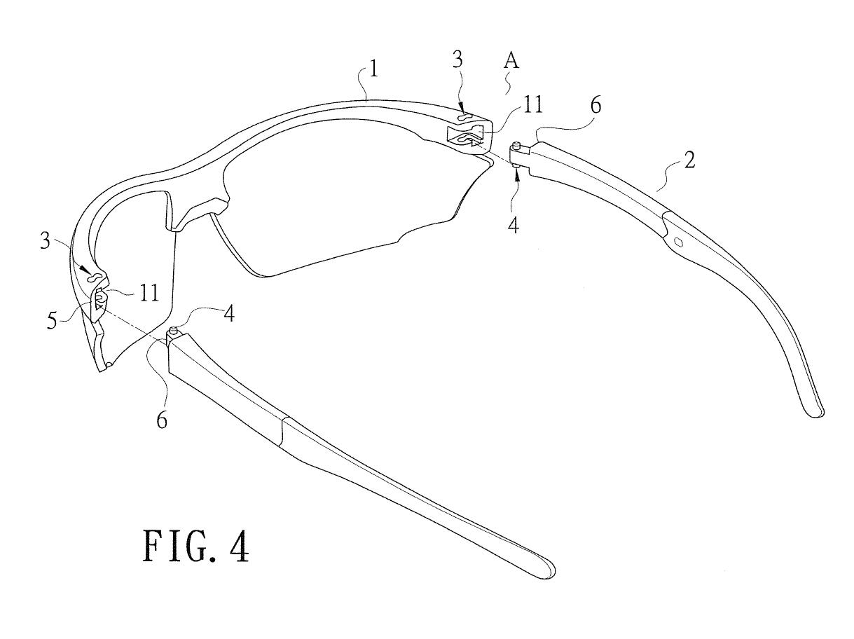

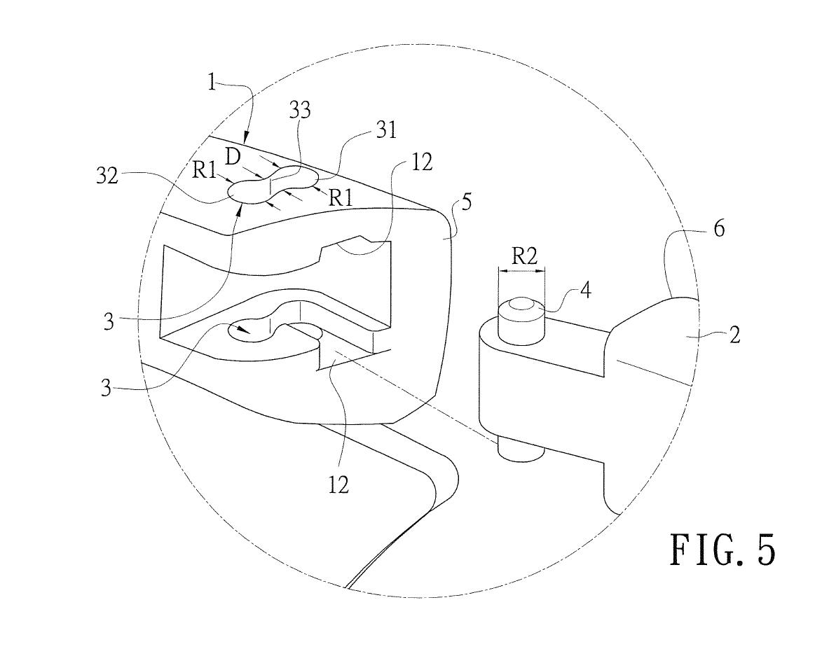

Refer to FIG. 4 and FIG. 5, a fitness adjustment mechanism A for eyeglass temples of this embodiment is arranged between an eyeglass frame 1 and a temple 2. The fitness adjustment mechanism A includes at least one adjustment hole 3, a projecting pin 4, an inclined contact surface 5 and a contact surface 6. The adjustment hole 3 is disposed on one end of the eyeglass frame 1 that connects to the temple 2. The inclined contact surface 5 is arranged at the edge of one end of the eyeglass frame 1 while the projecting pin 4 is set on one end of the temple 2 that connects to the eyeglass frame 1. The contact surface 6 is disposed on the edge of one end of the temple 2 and is against and in contact with the inclined contact surface 5. The connections among the eyeglass frame 1, the temple 2, the adjustment hole 3 and the projecting pin 4 is the same as the embodiment shown in FIG. 1.

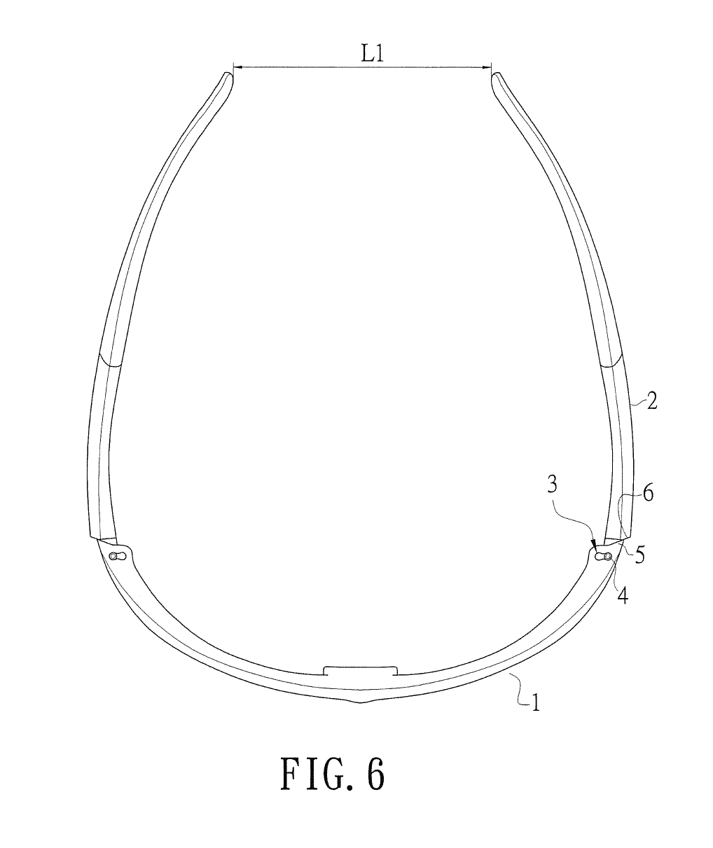

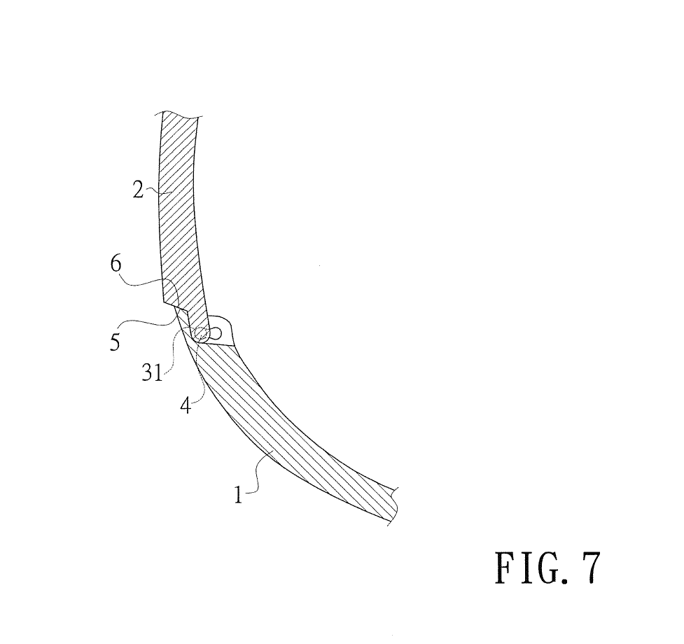

Refer to FIG. 6 and FIG. 7, a schematic drawing showing the projecting pin 4 being mounted into the receiving fixing slot 31 is revealed. In such state, an inner surface of the contact surface 6 is leaning against an outer end of the inclined contact surface 5 so as to restrict the angle of the temple 2 being extended outward. At the moment, the distance L1 between two rear ends of the two temples 2 is smaller so that the fitness provided is improved.

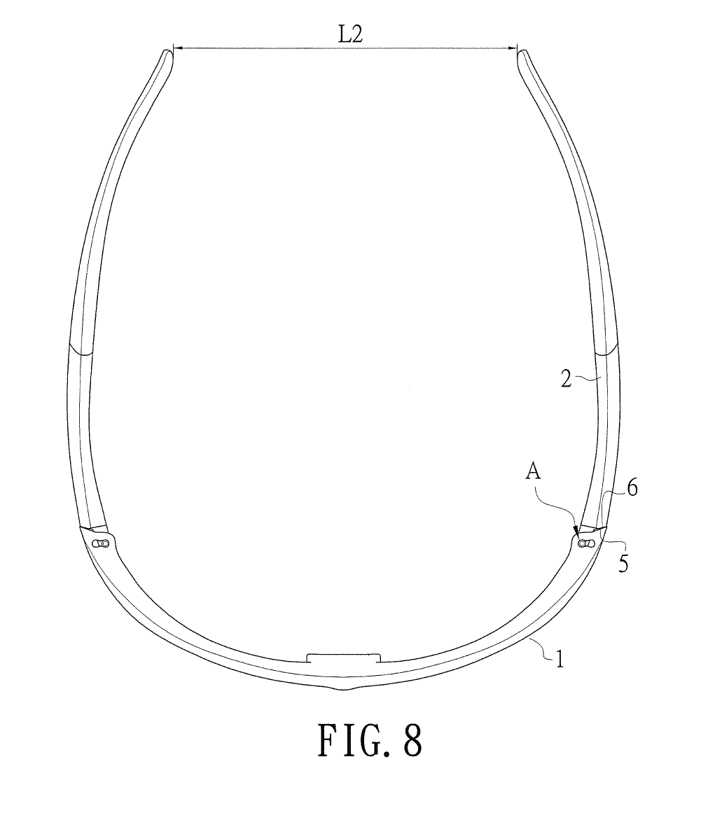

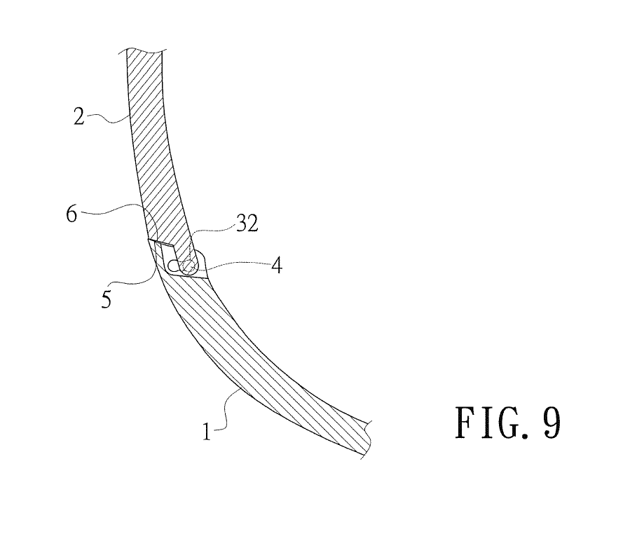

Refer to FIG. 8 and FIG. 9, the projecting pin 4 is passed through the channel 33 and is mounted into the receiving fixing slot 32. In the state, the contact surface 6 is in contact with the whole surface of the inclined contact surface 5 by the whole surface thereof. Compared with the above state, the angle of the temple 2 being extended outward is less restricted. The distance L2 between two rear ends of the two temples 2 is larger than L1 (L2>L1). Thus the eyeglass frame 1 together with the two temples 2 is looser.

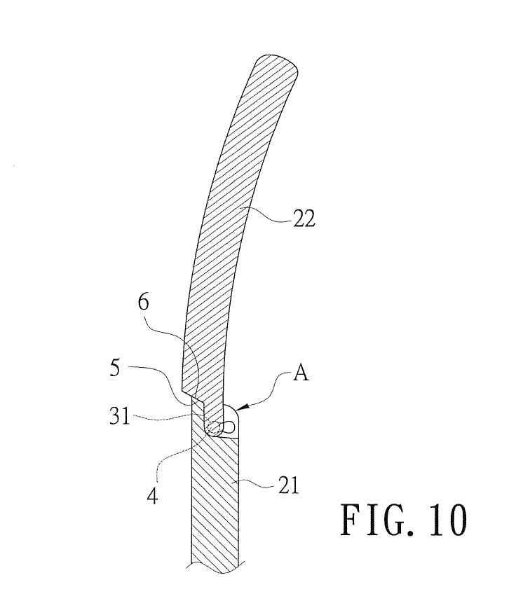

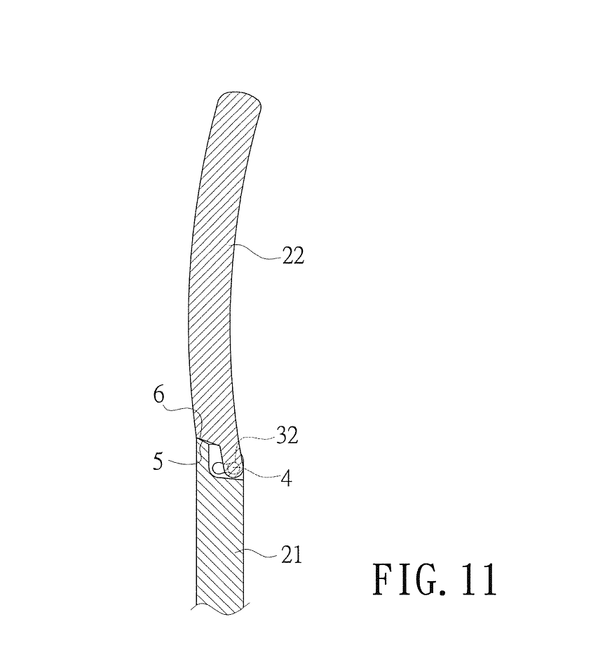

Refer to FIGS. 1, 5, 10 and 11, a fitness adjustment mechanism A for eyeglass temples of this embodiment is disposed between a first connection segment 21 and a second connection segment 22 of a temple 2. The end of the first connection segment 21 that connects to the second connection segment 22 is further arranged with a slot 211 while a top wall and a bottom wall of the slot 211 are respectively arranged with a guide groove 212 that communicates with the adjustment hole 3. Thereby by the projecting pin 4 being mounted into different receiving fixing slots 31, 32 of the adjustment hole 3 through the guide grooves 212 together with a leaning position between the inclined contact surface 5 and the contact surface 6, the angle of the temple 2 is changed. Thus the fitness between the temples 2 and the users' faces is properly adjusted. With the properly adjusted temples, the eyeglasses stay comfortably in place.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A fitness adjustment mechanism for eyeglass temples disposed between an eyeglass frame and a temple comprising: at least one adjustment hole and at least one projecting pin; wherein a receiving fixing slot is formed on each of two ends of the adjustment hole and a narrow channel is located between the two receiving fixing slots; a transverse distance of the channel is smaller than an inner diameter of the receiving fixing slot; a diameter of the projecting pin is no more than the inner diameter of the receiving fixing slot and is a bit larger than the transverse distance of the channel; an angle of the temple is changed by the projecting pin being mounted into one of the receiving fixing slots.

2. The device as claimed in claim 1, wherein the fitness adjustment mechanism further includes an inclined contact surface and a contact surface; the inclined contact surface and the contact surface are corresponding to each other and are respectively arranged at the eyeglass frame and the temple; the angle of the temple is changed by the projecting pin being mounted into one of the receiving fixing slots together with a leaning position between the contact surface and the inclined contact surface.

3. The device as claimed in claim 2, wherein an end of the eyeglass frame that connects to the temple is arranged with a slot; a top wall and a bottom wall of the slot are respectively disposed with a guide groove; the guide groove communicates with the adjustment hole.

4. The device as claimed in claim 1, wherein an end of the eyeglass frame that connects to the temple is arranged with a slot; a top wall and a bottom wall of the slot are respectively disposed with a guide groove; the guide groove communicates with the adjustment hole.

5. A a fitness adjustment mechanism for eyeglass temples being disposed between a first connection segment and a second connection segment of a temple comprising: at least one adjustment hole and at least one projecting pin; wherein a receiving fixing slot is formed on each of two ends of the adjustment hole and a narrow channel is located between the two receiving fixing slots; a transverse distance of the channel is smaller than an inner diameter of the receiving fixing slot; a diameter of the projecting pin is no more than the inner diameter of the receiving fixing slot and is a bit larger than the transverse distance of the channel; an angle of the temple is changed by the projecting pin being mounted into one of the receiving fixing slots.

6. The device as claimed in claim 5, wherein the fitness adjustment mechanism further includes an inclined contact surface and a contact surface; the inclined contact surface and the contact surface are corresponding to each other and are respectively arranged at the first connection segment and the second connection segment; the angle of the temple is changed by the projecting pin being mounted into one of the receiving fixing slots together with a leaning position between the contact surface and the inclined contact surface.

7. The device as claimed in claim 6, wherein an end of the first connection segment that connects to the second connection segment is arranged with a slot; a top wall and a bottom wall of the slot are respectively disposed with a guide groove; the guide groove communicates with the adjustment hole.

8. The device as claimed in claim 5, wherein an end of the first connection segment that connects to the second connection segment is arranged with a slot; a top wall and a bottom wall of the slot are respectively disposed with a guide groove; the guide groove communicates with the adjustment hole.
